(19) United States
(12) Patent Application Publication
(10) Pub. No.: US 2009/0009318 A1
(43) Pub. Date: Jan. 8, 2009

(54) REMOTE DATA COLLECTION USING MESH TECHNOLOGY

(76) Inventor: JOHN MURRAY SPRUTH, HOUSTON, TX (US)

Correspondence Address: CONLEY ROSE, P.C.;David A. Rose, P. O. BOX 3267, HOUSTON, TX, 77253-3267, US

(21) Appl. No.: 11/952,787

(22) Filed: Dec. 7, 2007

Related U.S. Application Data
(60) Provisional application No. 60/868,980, filed on Dec. 7, 2006.

(51) Int. Cl. G08C 17/02

(52) U.S. Cl. 340/539.1

(57) ABSTRACT

A system comprises a plurality of instruments for gathering data and a network of mesh nodes communicably coupled to the plurality of instruments, the mesh nodes for obtaining the data from the instruments. The system also comprises a concentrator mesh node. The network of mesh nodes transmits the data to the concentrator mesh node while the concentrator mesh node is airborne. The concentrator mesh node receives the data and, when the concentrator mesh node is no longer airborne, the concentrator mesh node transfers the data to a destination via a network.

### CROSS-REFERENCE TO RELATED APPLICATION

This application claims priority to U.S. Provisional Application No. 60/868,980, filed Dec. 7, 2006 and incorporated herein by reference.

### BACKGROUND

Many applications require the collection of data from multiple sources spread out over a large geographical area. For example, in some applications, field monitoring equipment spread out over several square yards or even miles regularly logs data that needs to be harvested and processed. Collecting data over such large geographical areas presents numerous logistical challenges.

### BRIEF DESCRIPTION OF THE DRAWINGS

For a detailed description of illustrative embodiments of the invention, reference will now be made to the accompanying drawings in which:

FIG. 1 shows an illustrative mesh network system comprising a plurality of mesh nodes, in accordance with various embodiments;

FIG. 2 shows an illustrative mesh network system comprising a mesh analog module, a mesh digital module, a mesh RFID module, a mesh hub/concentrator module and another mesh concentrator module, in accordance with various embodiments;

FIG. 3 shows an illustrative mesh network system comprising mesh modules, in accordance with various embodiments;

FIG. 4 shows an illustrative mesh network system comprising an oil and/or gas pipeline data acquisition and control system, in accordance with various embodiments; and

FIG. 5 shows an illustrative mesh network system comprising a pipeline data acquisition system, in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. The term “connection” refers to any path via which a signal may pass. For example, the term “connection” includes, without limitation, wires, traces and other types of electrical conductors, optical devices, etc.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be illustrative of that embodiment, and not intended to intimate that the scope of the disclosure, including the claims, is limited to that embodiment.

Mesh technology comprises a decentralized network formed between individual wireless transceivers (or “nodes”). This type of decentralized network infrastructure is inexpensive, reliable and resilient. Each node may function as a repeater, receiving and transmitting data from one node to another. Mesh networks are considerably reliable because each node can connect to several different nodes, and if one node drops out of the network (thereby damaging a particular data route), another data route (comprising a different combination of nodes) may be used in lieu of the damaged route. Each node is programmed to process received data in a specific way: the node may pass the data to another node, or the node may retain the received data. A node that is programmed to retain data is defined as a “destination” or “concentrator” node and often provides gateway services to other data sources or data sinks (a data sink may be defined as a device that receives information data, control commands or other signals from a source (e.g., a connection to the Internet, SCADA systems, control computer, etc.)).

The mesh network disclosed herein is able to transmit and receive commands and/or data (e.g., empirical data) to and from entities external to the network. Transceivers used in the mesh network for such communications include wireless mesh ultra-low power (ULP) transceivers. The ULP transceiver preferably operates in the license-free industrial-scientific-medical (ISM) 433, 868, and 915 MHz frequency bands, and uses Frequency Hopping Spread Spectrum (FHSS), Gaussian Frequency Shift Keying (GFSK), Automatic Frequency Control (AFC), data interleaving and broadcast channel (BCH) Forward Error Correction techniques to provide optimal performance over the operating lifetime. The transceiver protocol stack has point-to-point, point-to-multipoint (broadcast polling) and repeater modes, tree, star and mesh network topologies, self-configuration and dynamic routing algorithm optimized for ULP networks, relaxed synchronization message passing and a programmable standby-receive duty cycle (˜10 milliseconds to ˜10 seconds range). Each mesh transceiver comprises an identifier unique to the network, similar to a media access control (MAC) address. A data packet from a node preferably contains the node ID. Commands and data also may be directed to a particular node by specifying the node ID as the destination.

In accordance with embodiments of the invention, one or more nodes in the mesh network collects data and transfers the collected data to other nodes and/or to a concentrator node. The concentrator node (sometimes referred to as a “gateway” node) may be located on the earth or above the earth. For example, the concentrator/gateway node may be located within an aircraft (e.g., an airplane, blimp, helicopter, hot air balloon), a satellite (e.g., geostationary, low-earth orbit (LEO) satellite), or on a transmission tower, electric utility pole, or any other suitable location for collecting data from the nodes en masse. In some embodiments, multiple concentrator nodes may be used.

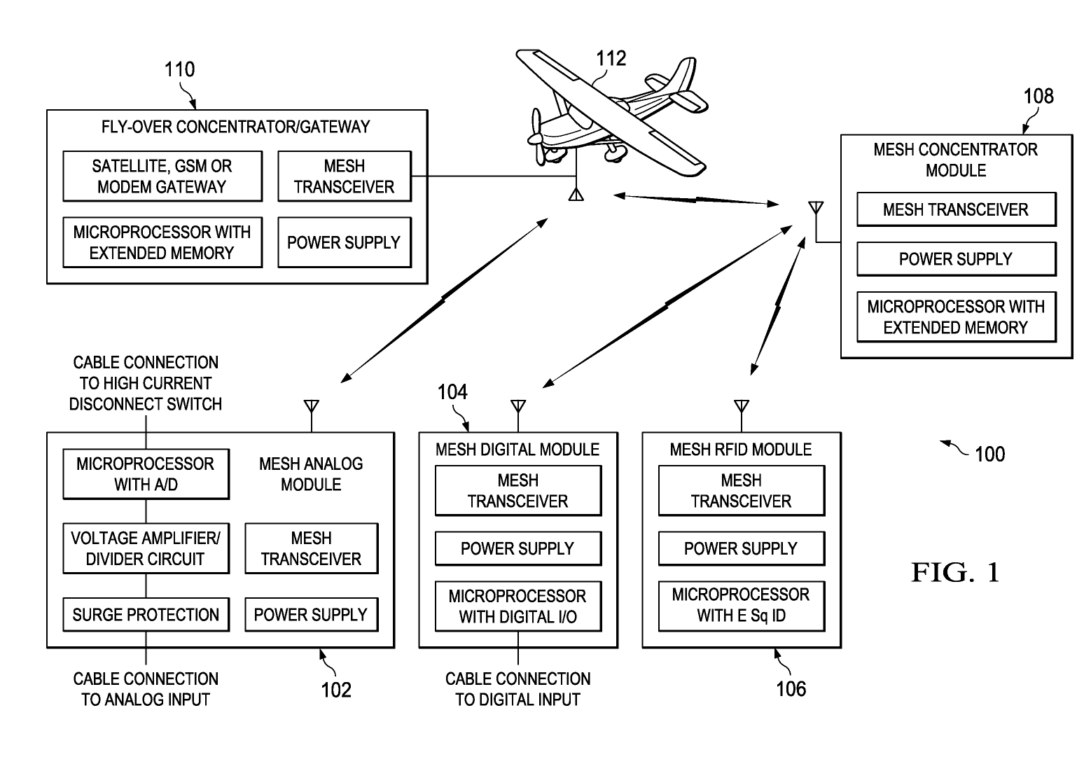

FIG. 1 shows an illustrative mesh network system 100 comprising a plurality of mesh nodes. Specifically, the nodes include a mesh analog module 102, a mesh digital module 104, a mesh RFID module 106, a mesh hub/concentrator module 108 and a concentrator/gateway module 110 contained within an aircraft 112 (preferably a manned aircraft). Each of the modules 102, 104, 106, 108 and 110 comprises a power supply (preferably engaged in ultra-low power (ULP) consumption techniques), processor logic, memory, a transceiver and an antenna. These components are used to collect, process, transmit and receive data to and from other mesh nodes. Each of these modules collects data from its environment (as described below) and transmits the collected data either directly or indirectly to the concentrator/gateway module 110 in the aircraft 112. For instance, as shown in FIG. 1, mesh analog module 102 transmits data directly to the concentrator/gateway module 110. The mesh digital module 104 and the mesh RFID module 106, however, transmit their data to the mesh concentrator module 108. In turn, the mesh concentrator module 108 receives the data and transmits the received data, along with any of its own data, to the concentrator/gateway module 110. The concentrator/gateway module 110 receives the data and stores the data in memory. When the aircraft 112 lands, the module 110 is communicably coupled to a network (e.g., the Internet) and the data stored in the module 110 is transferred to a desired destination.

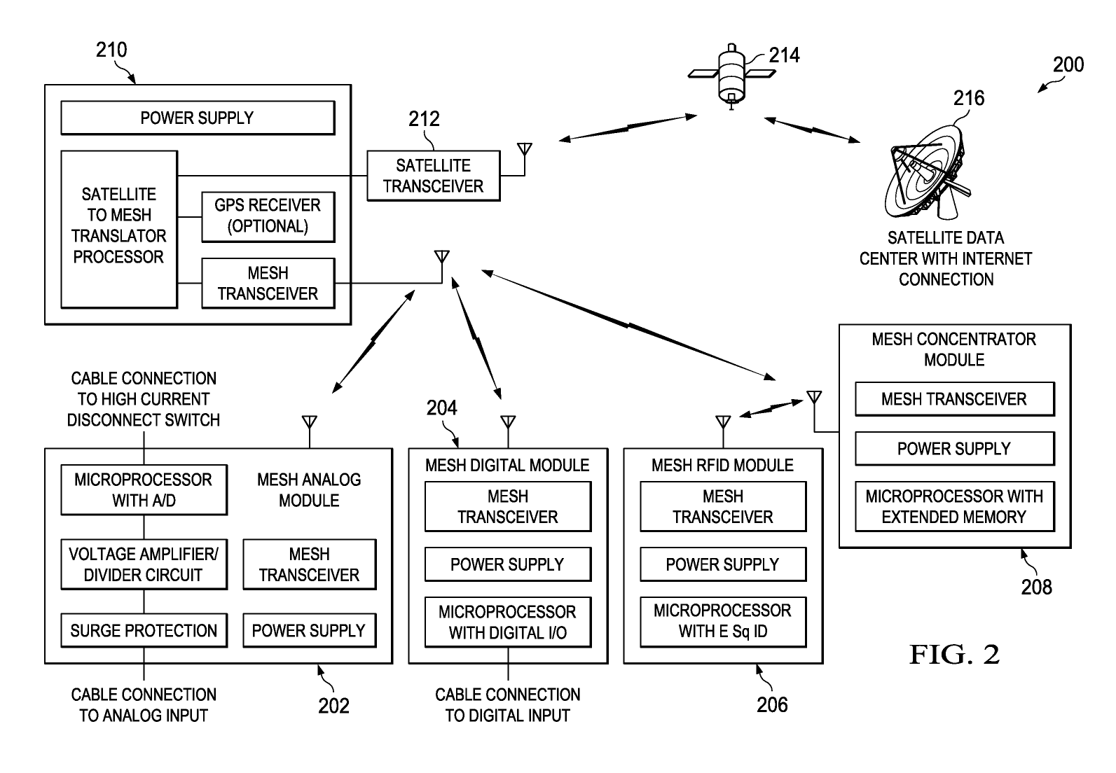

FIG. 2 shows an illustrative mesh network system 200 comprising a mesh analog module 202, a mesh digital module 204, a mesh RFID module 206, a mesh concentrator module 208 and a concentrator module 210. The module 210 couples to a satellite transceiver 212. In turn, the satellite transceiver 212 communicates with a satellite 214 (e.g., a geostationary or LEO satellite), and the satellite 214 communicates with a satellite data center 216. In operation, the modules 202, 204, 206 and 208 collect data from their surroundings (as described below) and transfer the collected data either directly or indirectly to the concentrator module 210. The concentrator module 210 receives the data and transmits the data to the satellite 214 via the satellite transceiver 212. In turn, the satellite 214 receives the data from the transceiver 212 and transmits the received data to the satellite data center 216. The satellite data center 216 preferably couples to a network connection (e.g., an Internet connection) by which the data center 216 transfers information to a predetermined destination (e.g., a Web site or another server not part of the data center 216).

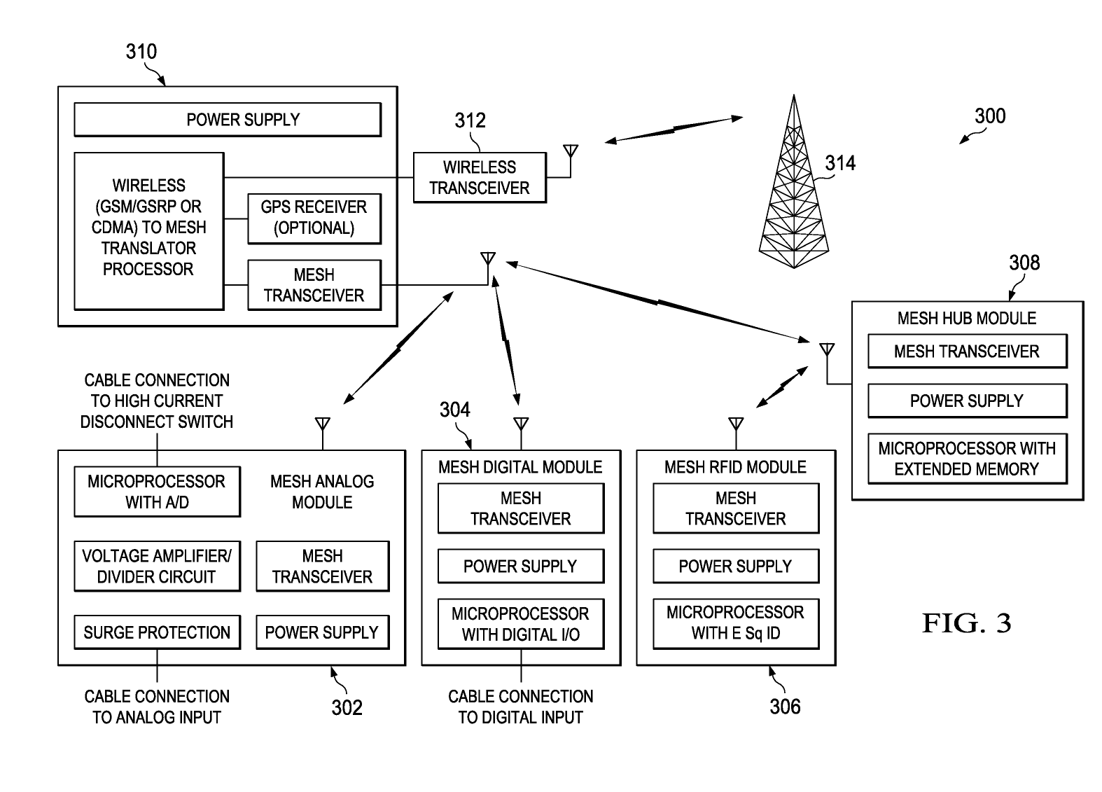

FIG. 3 shows an illustrative mesh network system 300 comprising mesh modules 302, 304, 306, 308 and 310. As in systems 100 and 200 of FIGS. 1 and 2, the modules 302, 304, 306 and 308 collect data from their surroundings (described below) and transmit the data (directly or indirectly) to the concentrator module 310. In turn, the concentrator module 310 transmits the received data, via the wireless transceiver 312, to a transmission tower 314. The tower 314 may be associated with any suitable wireless communication technique, including global system for mobile communications (GSM) and code division multiple access (CDMA). The tower 314 receives the data from the transceiver 312 and broadcasts the data to one or more predetermined destinations using GSM, CDMA or other suitable techniques.

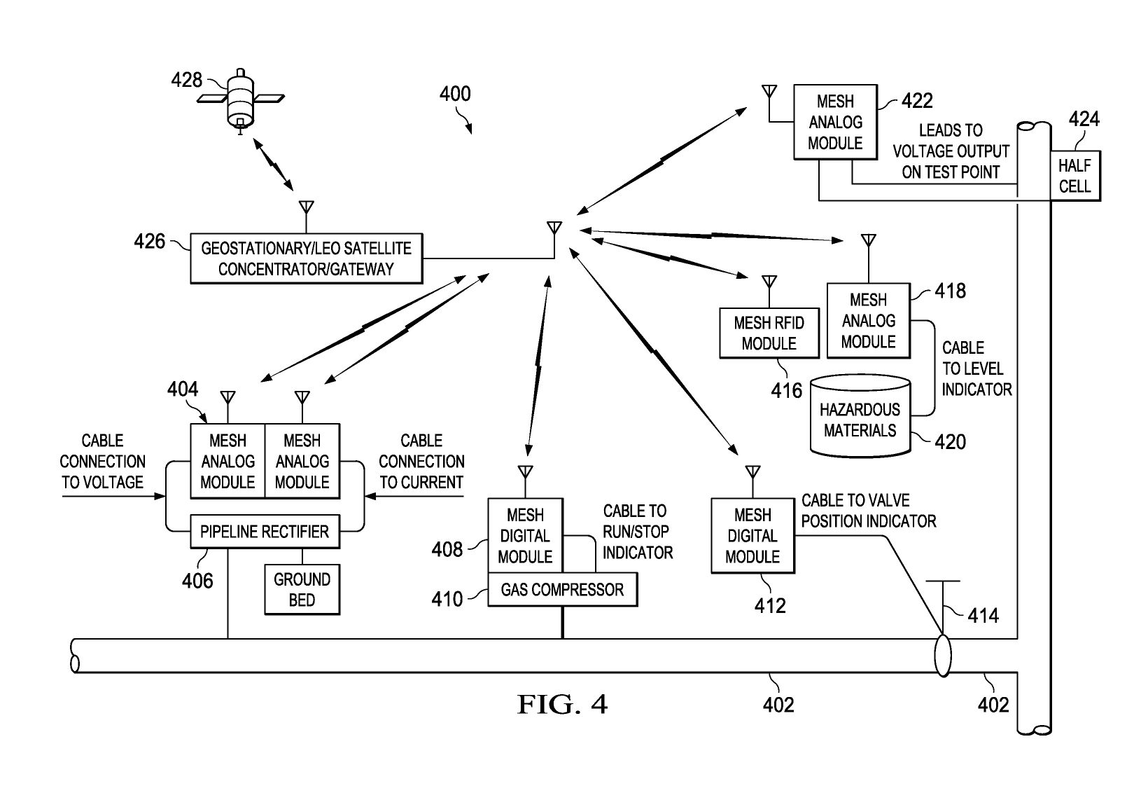

FIG. 4 shows an illustrative mesh network system 400 comprising an oil and/or gas pipeline 402. The pipeline may be coupled to various types of instrumentation used to maintain proper pipeline functionality, including a pipeline rectifier 406, gas compressor 410, valve 414, hazardous materials container 420 and a half cell 424. The operation of each of these instruments is monitored by a mesh node. Specifically, the rectifier 406 is monitored by the mesh analog modules 404; the gas compressor 410 is monitored by mesh digital module 408; the valve 414 is monitored by the mesh digital module 412; the hazardous materials container 420 is monitored by mesh RFID module 416 and/or mesh analog module 418; and the half cell 424 is monitored by the mesh analog module 422. Each of these mesh nodes collects data from its respective instrument and, after having collected the data, transmits the data to the concentrator/gateway module 426. The concentrator/gateway receives the data from the mesh nodes and transmits the data to a satellite 428. The satellite 428 receives the data and transmits the data, e.g., to a satellite data center such as that described in FIG. 2. The scope of disclosure is not limited to using a satellite 428. Any suitable data collection/gateway module may be used. Instrumentation and techniques for monitoring oil and gas pipelines are disclosed in U.S. Pat. Nos. 7,027,957 and 5,785,842, each of which is incorporated herein by reference.

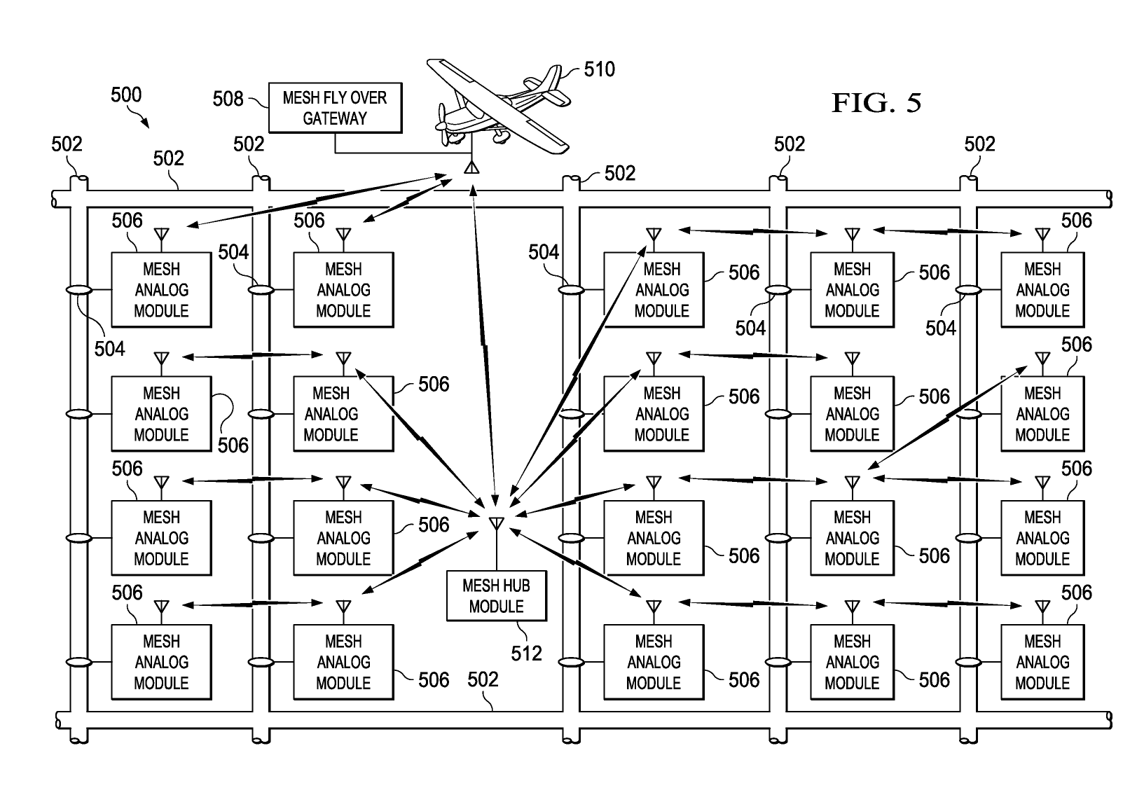

FIG. 5 shows an illustrative mesh network system 500 comprising a pipeline 502. The pipeline 502 comprises multiple pipeline test points 504. Each test point 504 comprises one or more instruments, such as those described in FIG. 4. Each test point 504 couples to a mesh node, such as the mesh analog modules 506 shown in FIG. 5. Each mesh node collects data from its respective instrument (or test point 504) and transmits the data either directly or indirectly to the gateway module 508 contained in aircraft 510. For example, some mesh nodes transmit data directly to the gateway module 508, whereas other mesh nodes transmit data to a mesh hub module 512. In turn, the mesh hub module 512 gathers data and transmits the data to the gateway module 508 in the aircraft 510. The gateway module 508 stores the received data until the aircraft 510 lands, whereupon the data is extracted and transmitted to a predetermined destination as described in FIG. 1. The scope of disclosure is not limited to using aircraft 510. Any suitable means suitable for carrying the gateway module 508 may be used. In some embodiments, the mesh nodes are mobile.

As described above, each mesh analog module collects data from an associated instrument. In some embodiments, each mesh analog module calculates values for a wide range of voltage inputs. Inputs may range from 0.0001 Volts to 1000 Volts of direct current (DC), rectified DC, or alternating current (AC) in harsh environments.

One or more of the nodes described above may be powered with primary batteries, a solar panel/rechargeable battery system, or a permanent A/C or D/C power source. When powered with permanent power source, backup primary batteries are available in the event of a power outage. When operating off solar or a permanent power source, the node maintains a persistent Internet connection. The persistent connection allows a user to quickly retrieve data and to send commands or data to individual nodes via the node. If a node is using primary or backup batteries, the node enters a power saving state. In this state, the node may connect to the Internet and transmits data to and receives data from a data center on a preprogrammed schedule. A node can include a global positioning system (GPS) receiver to provide precise latitude and longitude coordinates at the time data is transmitted and accurate updates to the system's real time clock.

In some embodiments, the mesh networks may include computer software that protects equipment during periods of high lightning activity and in areas likely to cause electrical surges. A remote server monitors real-time lightning strike data to determine a lightning threat assessment. The threat assessment takes into account the time, intensity and location of a lightning strike with respect to the location of equipment connected to the mesh network. If the threat assessment is high, the remote server sends a threat command to the appropriate mesh gateway/concentrator associated with some or all of the equipment at risk to disconnect from any surge path (e.g., a pipeline). In turn, the mesh gateway broadcasts a command to a disconnect switch on the equipment through a mesh node. The disconnect switch is a high current, high isolation type of switch that may be in the form of a relay or other type of electromechanical switch. When the threat assessment has returned to a non-threatening level, a command is broadcast to reconnect the equipment as it was connected prior to the threat command.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a plurality of instruments for gathering data;
a network of mesh nodes communicably coupled to the plurality of instruments, said mesh nodes for obtaining said data from the instruments; and
a concentrator mesh node;
wherein the network of mesh nodes transmits said data to the concentrator mesh node while said concentrator mesh node is airborne;
wherein the concentrator mesh node receives the data and, when the concentrator mesh node is no longer airborne, the concentrator mesh node transfers said data to a destination via a network.

2. The system of claim 1, wherein said concentrator mesh node is contained within or coupled to an apparatus selected from the group consisting of a geostationary satellite, a low-earth orbit satellite, an airplane and a helicopter.

3. The system of claim 2, wherein said apparatus comprises a manned aircraft.

4. The system of claim 1, wherein said concentrator mesh node is coupled to a wireless transmission tower.

5. The system of claim 4, wherein the wireless transmission tower uses either global system for mobile communications (GSM) technology or code division multiple access (CDMA) technology.

6. The system of claim 1, wherein at least some of the mesh nodes are powered using a source selected from the group consisting of a primary battery, a solar panel, a rechargeable battery system, a permanent alternating current power source and a permanent direct current power source.

7. The system of claim 1, wherein at least one of the mesh nodes is capable of accepting a data input ranging from 0.0001 Volts to 1000 Volts of direct current, rectified direct current or alternating current.

8. The system of claim 1, wherein at least some of the mesh nodes are mobile.

9. A method, comprising:
gathering data using a plurality of instruments;
obtaining data from said instruments using mesh nodes;
transmitting said data from the mesh nodes to a concentrator mesh node while said concentrator mesh node is airborne;
receiving and storing said data on the concentrator mesh node; and
when the concentrator mesh node is no longer airborne, transferring said data from the concentrator mesh node to a destination.

10. The method of claim 9, wherein said concentrator mesh node is contained within or coupled to an apparatus selected from the group consisting of a geostationary satellite, a low-earth orbit satellite, an airplane and a helicopter.

11. The method of claim 10, wherein said apparatus comprises a manned aircraft.

12. The method of claim 9, wherein said concentrator mesh node is coupled to a wireless transmission tower.

13. The method of claim 12, wherein the wireless transmission tower uses either global system for mobile communications (GSM) technology or code division multiple access (CDMA) technology.

14. The method of claim 9 further comprising powering at least some of the mesh nodes using a source selected from the group consisting of a primary battery, a solar panel, a rechargeable battery system, a permanent alternating current power source and a permanent direct current power source.

15. The method of claim 9, wherein at least one of the mesh nodes is capable of accepting a data input ranging from 0.0001 Volts to 1000 Volts of direct current, rectified direct current or alternating current.

16. The method of claim 9, wherein at least some of the mesh nodes are mobile.

17. A system, comprising:
means for gathering data (plurality of instruments);
means for obtaining data from said means for gathering (MESH NODES);
means for transmitting said data from the means for obtaining to a concentrator mesh node while said concentrator mesh node is airborne;
means for receiving and storing said data on the concentrator mesh node; and
means for transferring said data from the concentrator mesh node to a destination.

18. The system of claim 17, wherein said concentrator mesh node is contained within or coupled to a manned flight vehicle.

19. The system of claim 17, wherein said concentrator mesh node communicably couples to a wireless transmission tower.

20. The system of claim 17, wherein said means for obtaining data is mobile.
